(19) United States
(12) Patent Application Publication
(10) Pub. No.: US 2019/0099752 A1
(43) Pub. Date: Apr. 4, 2019

(54) FLUIDIC DEVICE

(71) Applicants: The University of Tokyo, Tokyo (JP); NIKON CORPORATION, Tokyo (JP)

(72) Inventors: Takanori ICHIKI, Tokyo (JP); Hiromi TAKARADA, Tokyo (JP); Ryo KOBAYASHI, Kawasaki-shi (JP); Taro UENO, Tokyo (JP); Naoya ISHIZAWA, Saitama-shi (JP)

(21) Appl. No.: 16/208,430

(22) Filed: Dec. 3, 2018

Related U.S. Application Data
(63) Continuation of application No. PCT/JP2017/020947, filed on Jun. 6, 2017.

(30) Foreign Application Priority Data
Jun. 7, 2016 (JP) 2016-113329

(51) Int. Cl. B01L 3/00; G01N 35/08

(52) U.S. Cl. CPC B01L 3/5027; B01L 2400/0487; B01L 2400/0415; G01N 35/08

(57) ABSTRACT

A fluidic device includes a flow path through which a solution is introduced, and a reservoir in which the solution is accommodated and configured to supply the solution to the flow path. The reservoir has a length in a direction in which the solution flows toward the flow path, which is larger than a width perpendicular to the length.

### CROSS-REFERENCE TO RELATED APPLICATION

Priority is claimed on Japanese Patent Application No. 2016-113329, filed Jun. 7, 2016. The present application is a continuation application of International Application PCT/JP2017/020947, filed on Jun. 6, 2017. The contents of the above applications are incorporated herein.

### BACKGROUND

### Technical Field

The present invention relates to a fluidic device.

In recent years, the development of micro-total analysis systems (μ-TAS) with an aim of high-speed, high efficiency, and integrated testing in the field of extracorporeal diagnosis or micro-miniaturization of analysis equipment has attracted attention, and active research thereon is underway worldwide.

μ-TAS is superior in comparison with analysis equipment in the related art in that measurement and analysis can be performed with a small amount of specimen, and that systems are portable, and disposable due to having a low cost, and so on. Further, the μ-TAS is drawing attention as a method with high usefulness when expensive reagents are used or when small amounts of multiple-specimen are analyzed.

A device including a flow path and a pump disposed on the flow path has been reported as a component of the μ-TAS (Jong Wook Hong, Vincent Studer, Giao Hang, W French Anderson and Stephen R Quake, Nature Biotechnology 22, 435-439 (2004)). In such a device, a plurality of solutions are mixed together in the flow path by injecting a plurality of solutions into the flow path and operating the pump.

### SUMMARY

According to a first aspect of the invention, there is provided a fluidic device including: a flow path into which a solution is introduced; and a reservoir in which the solution is received and that supplies the solution to the flow path, wherein the reservoir has a length in a direction in which the solution flows toward the flow path, and the length of the reservoir is larger than a width of the reservoir which is perpendicular to the direction in which the solution flows.

According to a second aspect of the invention, there is provided a fluidic device including: a flow path; a first reservoir in which a first solution is accommodated, that supplies the first solution to the flow path, and that has a length in a direction in which the first solution flows toward the flow path, and the length of the first reservoir is larger than a width of the first reservoir which is perpendicular to the direction in which the first solution flows; and a second reservoir in which a second solution is accommodated, that supplies the second solution to the flow path, and that has a length in a direction in which the second solution flows toward the flow path, and the length of the second reservoir is larger than a width of the second reservoir which is perpendicular to the direction in which the second solution flows.

According to a third aspect of the invention, there is provided a fluidic device including: a substrate having a first surface in which a flow path to which a solution is introduced is formed; a second substrate stacked on and bonded to the substrate while facing the first surface; and a reservoir in which the solution is accommodated, that supplies the solution to the flow path, and that has a length in a direction in which the solution flows toward the flow path, and the length of the reservoir is larger than a width of the reservoir which is perpendicular to the direction in which the solution flows, wherein, when seen in a direction in which the substrate and the second substrate are stacked, at least a part of the flow path and at least a part of the reservoir overlaps with each other.

According to a fourth aspect of the invention, there is provided a fluidic device including: a flow path formed in one surface of a substrate and in which quantification or mixing of solutions is performed; and a reservoir that is formed parallel to the other surface of the substrate which is formed at opposite side of the one surface of the substrate, in which the solution is accommodated, and that supplies the solution to the flow path.

According to a fifth aspect of the invention, there is provided a fluidic device including: a substrate; and a reservoir that is formed in the substrate and that includes at least two first flow paths which are parallel to each other and at least three second flow paths which are parallel to each other in a direction perpendicular to the first flow paths, wherein the reservoir is formed in a zigzag shape in which the two first flow paths and the three second flow paths are alternately and repeatedly connected.

According to a sixth aspect of the invention, there is provided a fluidic device including: a reservoir disposed on one surface of a substrate and in which a solution is accommodated, wherein the reservoir is constituted by a cavity formed in an in-plane direction of the one surface.

According to a seventh aspect of the invention, there is provided a fluidic device including: a reservoir installed in a substrate and in which a solution is accommodated, wherein the reservoir comprises a curved flow path.

### BRIEF DESCRIPTION OF THE DRAWINGS

FIG. 1 is a schematic front view of a fluidic device according to an embodiment.

FIG. 2 is a plan view schematically showing the fluidic device according to the embodiment.

FIG. 3 is a cross-sectional view taken along line in FIG. 2.

FIG. 4 is a bottom view of a substrate according to the embodiment.

FIG. 5 is a plan view schematically showing the fluidic device according to the embodiment from a reservoir side.

FIG. 6 is a schematic plan view of the fluidic device according to the embodiment.

FIG. 7 is a bottom view schematically showing a reservoir layer according to the embodiment.

FIG. 8 is a schematic plan view of the fluidic device according to the embodiment.

FIG. 9 is a schematic plan view of the fluidic device according to the embodiment.

FIG. 10 is a schematic plan view of the fluidic device according to the embodiment.

FIG. 11 is a schematic plan view of the fluidic device according to the embodiment.

FIG. 12 is a plan view showing a variant of the reservoir according to the embodiment.

### DESCRIPTION OF THE EMBODIMENTS

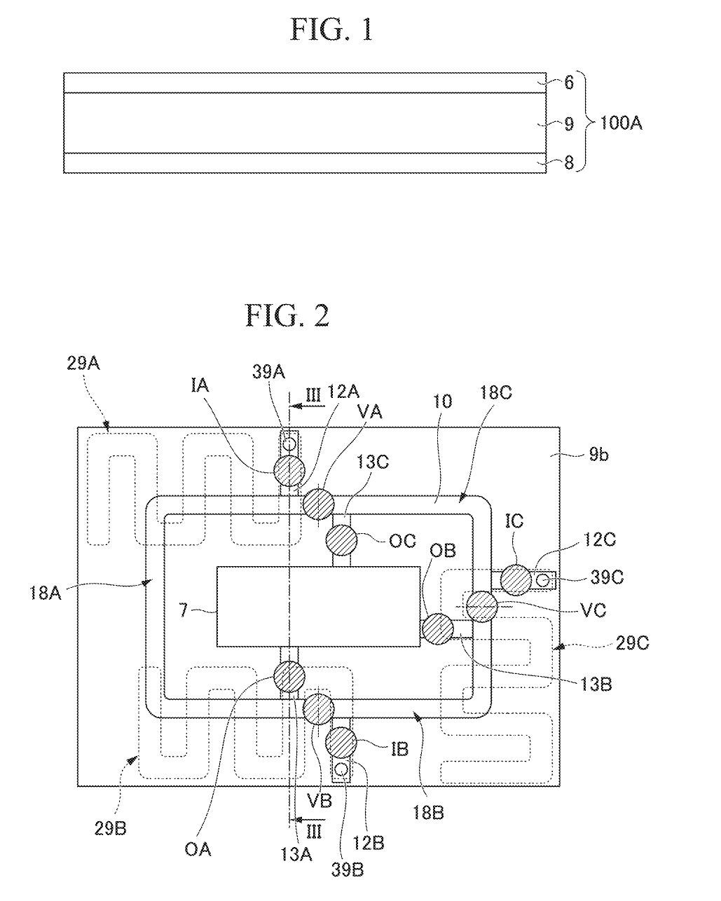

Hereinafter, an embodiment of a fluidic device will be described with reference to FIGS. 1 to 11. Further, in the drawings used in the following, for the sake of allowing easy understanding of features, there are cases where the characteristic portions are enlarged for the sake of convenience, and the dimensional proportions of each component may not be the same as actual ones.

### First Embodiment

FIG. 1 is a front view of a fluidic device 100A of a first embodiment. FIG. 2 is a plan view schematically showing the fluidic device 100A. Further, in FIGS. 1 and 2, illustration of an air flow path configured to discharge air from or introduce air into a flow path when a liquid is introduced is omitted.

The fluidic device 100A of the embodiment includes a device configured to detect a specimen substance that is a detection target included in an analytical specimen using an immunological response, an enzyme reaction, and so on. The specimen substance may be a biomolecule such as a nucleic acid, DNA, RNA, a peptide, a protein, extracellular endoplasmic reticulum, or the like. The fluidic device 100A includes an upper plate 6, a lower plate 8 and a substrate 9. The upper plate 6, the lower plate 8 and the substrate 9 are formed of a resin material (polypropylene, polycarbonate, or the like) as an example.

Further, in the following description, the upper plate (for example, a lid section, an upper section or a lower section of a flow path, an upper surface or a bottom surface of a flow path) 6, the lower plate (for example, a lid section, an upper section or a lower section of a flow path, an upper surface or a bottom surface of a flow path) 8 and the substrate 9 are disposed along a horizontal surface, the upper plate 6 is disposed above the substrate 9, and the lower plate 8 is disposed below the substrate 9. However, this is merely a definition of a horizontal direction and an upward/downward direction for the convenience of description and does not limit an orientation of the fluidic device 100A according to the embodiment in use.

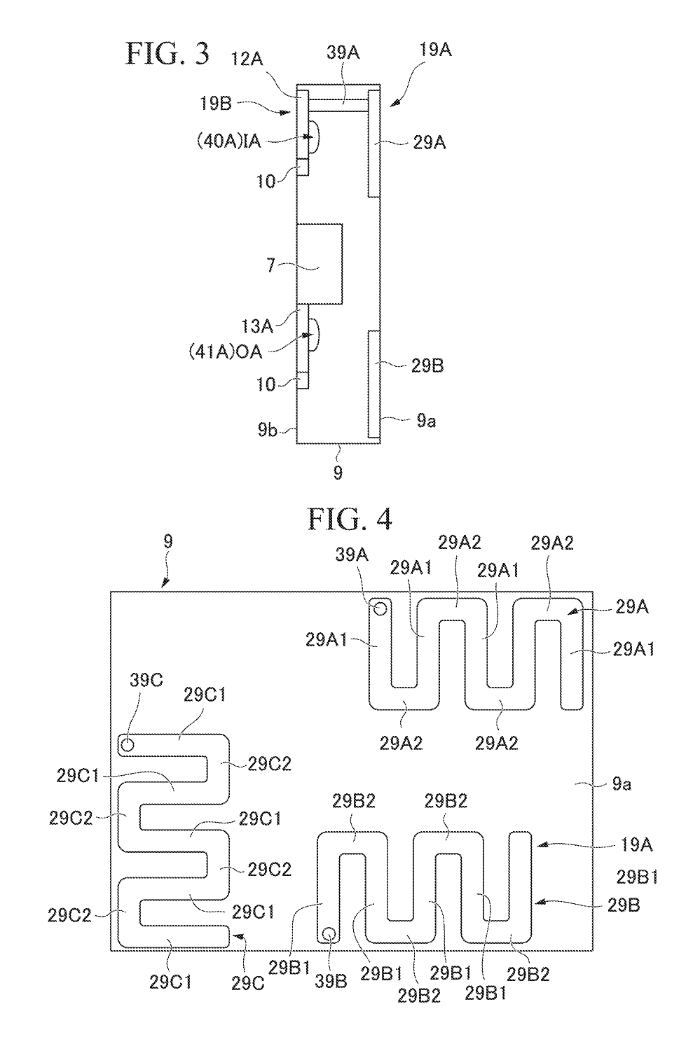

FIG. 2 is a plan view (a top view) of the substrate 9 when seen from the upper plate 6 side. FIG. 3 is a cross-sectional view taken along line in FIG. 2. FIG. 4 is a bottom view of the substrate 9. In FIG. 4, illustration of a form of an upper surface side is omitted.

As shown in FIG. 3, the substrate 9 includes a reservoir layer 19A on the side of a lower surface (one surface) 9a, and a reaction layer 19B on the side of an upper surface (the other surface) 9b. As shown in FIG. 4, the reservoir layer 19A has a plurality of (in FIG. 4, three) flow path type reservoirs 29A, 29B and 29C disposed on the lower surface 9a of the substrate 9. The flow path type reservoir is a reservoir constituted by an elongated flow path having a length larger than a width. The reservoirs 29A, 29B and 29C can accommodate solutions independently from each other. Each of the reservoirs 29A, 29B and 29C is constituted by a linear cavity (for example, a recess section) when the substrate 9 formed in an in-plane direction of the lower surface 9a (for example, one direction or a plurality of directions in a surface of the lower surface 9a, a direction parallel to a surface direction of the lower surface 9a, and so on) is seen from the upper plate 6 side. For example, the reservoirs 29A, 29B and 29C may be spaces formed in a tubular shape or a cylindrical shape when the lower plate 8 and the substrate 9 are bonded together. Bottom surfaces of the cavities of the reservoirs 29A, 29B and 29C are substantially flush with each other. The cavities in the reservoirs 29A, 29B and 29C have the same width. A cross section of the cavity is a rectangular shape as an example. For example, a width of the cavity is 1.5 mm and a depth thereof is 1.5 mm. Volumes of the cavities in the reservoirs 29A, 29B and 29C are set according to quantities of the solutions accommodated therein. For example, lengths of the reservoirs 29A, 29B and 29C are set according to quantities of the solutions accommodated therein. The reservoirs 29A, 29B and 29C according to the embodiment have different volumes with each other.

Further, a width and a depth of the cavity are merely examples and can be arbitrarily set according to a size of a fluidic device (a micro-fluidic device or the like) 100A to several pm to several hundreds of mm, for example, 1 μm to 999 mm, 0.01 μm or more and 100 mm or less, or the like.

The reservoirs 29A, 29B and 29C are formed in serpentine shapes extending in predetermined directions while the linear cavities are bend leftward and rightward. Describing the reservoir 29A, the reservoir 29A is formed in a serpentine shape including a plurality of (in FIG. 4, five) first linear sections 29A1 disposed parallel to a predetermined direction (in FIG. 4, a leftward/rightward direction), and second linear sections 29A2 that repeatedly connects connecting places of end portions of neighboring first linear sections 29A1 alternately at one end side and at the other end side of the first linear sections 29A1. In addition, each of the reservoirs 29B and 29C is formed in a serpentine shape like the reservoir 29A.

One end side of the reservoir 29A is connected to a penetration section 39A that penetrates the substrate 9 in a thickness direction (for example, a direction perpendicular to or a direction crossing the lower surface 9a or the upper surface 9b). The other end side of the reservoir 29A is connected to an atmospheric opening section (not shown). The atmospheric opening section may be a penetration section that penetrates the substrate 9 in the thickness direction with a diameter through which air can flow and a solution does not leak, or a groove section that connects the other end side of the reservoir 29A and an outer side of the substrate 9 with a depth through which air can flow and a solution does not leak. One end side of the reservoir 29B is connected to a penetration section 39B that penetrates the substrate 9 in the thickness direction. The other end side of the reservoir 29B is connected to an atmospheric opening section (not shown). One end side of the reservoir 29C is connected to a penetration section 39C that penetrates the substrate 9 in the thickness direction. The other end side of the reservoir 29C is connected to an atmospheric opening section (not shown). The atmospheric opening sections connected to the reservoirs 29B and 29C may be penetration sections or groove sections like the reservoir 29A.

For example, when the atmospheric opening sections connected to the reservoirs 29A, 29B and 29C are penetration sections, through-holes (not shown) that penetrate the upper plate 6 in the thickness direction are formed at positions facing the penetration sections in the upper plate 6 such that they are communicating with the penetration sections. The other end sides of the reservoirs 29A, 29B and 29C are opened to the atmosphere due to being connected to the penetration sections and the through-holes. In addition, since the through-holes communicating with the reservoirs 29A, 29B and 29C open to the upper surface of the upper plate 6, the solutions can be injected into the reservoirs 29A, 29B and 29C from the openings.

As shown in FIG. 2, the reaction layer 19B has a circulation flow path 10 disposed on the upper surface 9b of the substrate 9, introduction flow paths 12A, 12B and 12C, discharge flow paths 13A, 13B and 13C, a waste liquid tank 7, fixed quantity valves VA, VB and VC, introduction valves IA, IB and IC, and waste liquid valves OA, OB and OC.

The fixed quantity valves VA, VB and VC are disposed such that divisions of the circulation flow path 10 divided by the fixed quantity valves have predetermined volumes, respectively. For example, the fixed quantity valves VA, VB and VC divide the circulation flow path 10 into a first fixed quantity division 18A, a second fixed quantity division 18B and a third fixed quantity division 18C.

The introduction flow path 12A is connected to the penetration section (the penetration flow path) 39A on the one end side, and connected to the circulation flow path 10 on the other end side from the outside. A position at which the introduction flow path 12A is connected to the circulation flow path 10 is in the vicinity of the fixed quantity valve VA in the first fixed quantity division 18A. For example, the introduction flow path 12A and the reservoir 29A have portions that overlap each other when seen from above (for example, when seen from above the upper plate 6, the lower plate 8 and the substrate 9 in a stacking direction) and are connected to each other via the penetration section 39A disposed at the overlapping portion.

The introduction flow path 12B is connected to the penetration section 39B on one end side, and connected to the circulation flow path 10 on the other end side from the outside. A position at which the introduction flow path 12B is connected to the circulation flow path 10 is in the vicinity of the fixed quantity valve VB in the second fixed quantity division 18B. For example, the introduction flow path 12B and the reservoir 29B have portions that overlap each other when seen from above (for example, when seen from above the upper plate 6, the lower plate 8 and the substrate 9 in a stacking direction) and are connected to each other via the penetration section 39B disposed at the overlapping portion.

The introduction flow path 12C is connected to the penetration section 39C on one end side and connected to the circulation flow path 10 on the other end side from the outside. A position at which the introduction flow path 12C is connected to the circulation flow path 10 is in the vicinity of the fixed quantity valve VC in the third fixed quantity division 18C. For example, the introduction flow path 12C and the reservoir 29C have portions that overlap each other when seen from above (for example, when seen from above the upper plate 6, the lower plate 8, and the substrate 9 in the stacking direction) and are connected to each other via the penetration section 39C disposed on the overlapping portion.

For example, in the substrate 9, as the introduction flow paths 12A, 12B and 12C and the reservoirs 29A, 29B and 29C are connected to each other via the penetration sections 39A, 39B and 39C formed in the overlapping portions, respectively, distances between the introduction flow paths and the reservoirs (for example, distances over which the solutions flow) are shortened, a pressure loss when the solutions are introduced into the introduction flow paths from the reservoirs is reduced, and the solutions can be easily and rapidly introduced.

The introduction valve IA is disposed between the penetration section 39A in the introduction flow path 12A and the circulation flow path 10. The introduction valve IA includes a hemispherical cavity 40A (see FIG. 3) that divides the introduction flow path 12A and that is arranged in the substrate 9, and a deformation section (not shown) that is arranged in the upper plate 6 while facing the cavity 40 and that closes the introduction flow path 12A when it is electrically deformed to abut the cavity 40A, and that opens the introduction flow path 12A when it is separated from the cavity 40A. The introduction valve IB is disposed between the penetration section 39B in the introduction flow path 12B and the circulation flow path 10. The introduction valve IB includes a cavity (not shown, for the sake of convenience, referred to as a cavity 40B) that divides the introduction flow path 12B and that has the same shape as the cavity 40A arranged in the substrate 9, and a deformation section (not shown) that is arranged in the upper plate 6 while facing the cavity 40B and that closes the introduction flow path 12B when it is elastically deformed to abut the cavity 40B, and that opens the introduction flow path 12B when it is separated from the cavity 40B. The introduction valve IC is disposed between the penetration section 39C in the introduction flow path 12C and the circulation flow path 10. The introduction valve IC includes a cavity (not shown, for the sake of convenience, referred to as a cavity 40C) that divides the introduction flow path 12C and that has the same shape as the cavity 40A arranged in the substrate 9, and a deformation section (not shown) that is arranged in the upper plate 6 while facing the cavity 40C and that closes the introduction flow path 12C when it is electrically deformed to abut the cavity 40C, and that opens the introduction flow path 12C when it is separated from the cavity 40C.

As shown in FIGS. 2 and 3, for example, the waste liquid tank 7 is disposed on an inside region of the circulation flow path 10. Accordingly, reduction in size of the fluidic device 100A can be achieved. A tank suction hole (not shown) that opens toward the waste liquid tank 7 is formed in the upper plate 6 to penetrate the upper plate 6 in the thickness direction.

The discharge flow path 13A is a flow path configured to discharge a solution in the first fixed quantity division 18A in the circulation flow path 10 to the waste liquid tank 7. One end side of the discharge flow path 13A is connected to the circulation flow path 10. A position at which the discharge flow path 13A is connected to the circulation flow path 10 is in the vicinity of the fixed quantity valve VB in the first fixed quantity division 18A. The other end side of the discharge flow path 13A is connected to the waste liquid tank 7. In addition, the discharge flow path 13B is a flow path configured to discharge the solution in the second fixed quantity division 18B in the circulation flow path 10 to the waste liquid tank 7. One end side of the discharge flow path 13B is connected to the circulation flow path 10. A position at which the discharge flow path 13B is connected to the circulation flow path 10 is in the vicinity of the fixed quantity valve VC in the second fixed quantity division 18B. The other end side of the discharge flow path 13B is connected to the waste liquid tank 7. The discharge flow path 13C is a flow path configured to discharge the solution in the third fixed quantity division 18C in the circulation flow path 10 to the waste liquid tank 7. One end side of the discharge flow path 13C is connected to the circulation flow path 10. A position at which the discharge flow path 13C is connected to the circulation flow path 10 is in the vicinity of the fixed quantity valve VA in the third fixed quantity division 18C. The other end side of the discharge flow path 13C is connected to the waste liquid tank 7.

The waste liquid valve OA is disposed in the middle of the discharge flow path 13A (for example, midway, on the side of the circulation flow path 10). The waste liquid valve OA includes a hemispherical cavity 41A (see FIG. 3) that divides the discharge flow path 13A and is arranged in the substrate 9, and a deformation section (not shown) that is arranged in the upper plate 6 while facing the cavity 41A and that closes the discharge flow path 13A when it is electrically deformed to abut the cavity 41A, and that opens the discharge flow path 13A when it is separated from the cavity 41A. The waste liquid valve OB is disposed in the middle of the discharge flow path 13B (for example, midway, on the side of the circulation flow path 10). The waste liquid valve OB includes a cavity (not shown, for the sake of convenience, referred to as a cavity 41B) that divides the discharge flow path 13B and that has the same shape as the cavity 41A arranged in the substrate 9, and a deformation section (not shown) that is arranged in the upper plate 6 while facing the cavity 41B and that closes the discharge flow path 13B when it is elastically deformed to abut the cavity 41B, and that opens the discharge flow path 13B when it is separated from the cavity 41B. The waste liquid valve OC is disposed in the middle of the discharge flow path 13C (for example, midway, on the side of the circulation flow path 10). The waste liquid valve OC includes a cavity (not shown, for the sake of convenience, referred to as a cavity 41C) that divides the discharge flow path 13C and that has the same shape as the cavity 41A arranged in the substrate 9, and a deformation section (not shown) that is arranged in the upper plate 6 while facing the cavity 41C and that closes the discharge flow path 13C when it is elastically deformed to abut the cavity 41C, and that opens the discharge flow path 13C when it is separated from the cavity 41C.

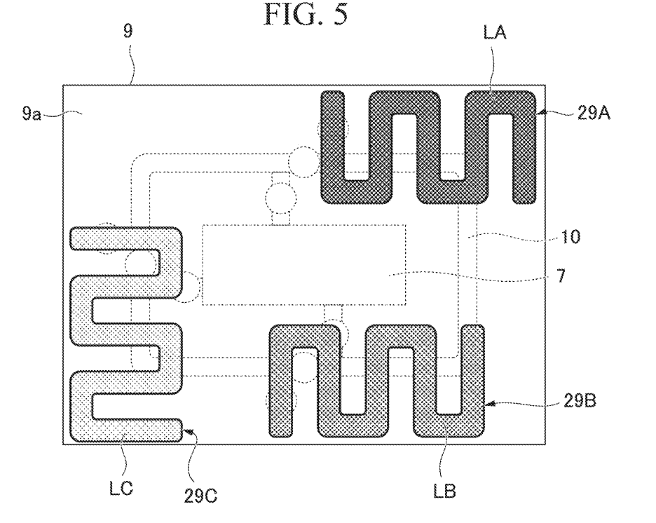

The fluidic device 100A having the above-mentioned configuration is manufactured by forming the circulation flow path, the introduction flow paths, the reservoirs, penetration sections, and so on, in the substrate 9, forming and installing the valves on the substrate 9 and the upper plate 6, and then, bonding and integrating the upper plate 6, the lower plate 8 and the substrate 9 using a bonding means such as adhesive or the like (for example, the configuration in FIG. 1 or the like). FIG. 5 is a plan view schematically showing the fluidic device 100A from the reservoir side. As shown in FIG. 5, a solution LA is accommodated in the reservoir 29A of the fluidic device 100A that is manufactured, a solution LB is accommodated in the reservoir 29B, and a solution LC is accommodated in the reservoir 29C. Injection of the solutions LA, LB and LC into the reservoirs 29A, 29B and 29C is performed from, for example, the opening sections of the through-holes formed in the upper plate 6. Upon injection of the solutions LA, LB and LC into the reservoirs 29A, 29B and 29C, as negative pressure suction from air holes in communication with one end sides of the reservoirs 29A, 29B and 29C is performed, the reservoirs 29A, 29B and 29C can be easily filled with the solutions LA, LB and LC. In this way, for example, the upper plate 6 forms the above-mentioned various flow paths together with the cavity formed in the substrate 9, and is used for both of reducing leakage of the solutions and formation of the flow paths. For example, the lower plate 8 forms the above-mentioned various reservoirs together with the cavity formed in the substrate 9 and is used for both of reducing leakage of the solutions and formation of the flow paths.

The fluidic device 100A can cause the solutions LA, LB and LC to flow to a place at which mixing/reaction of the solutions LA, LB and LC is performed (for example, an inspection institute, a hospital, a house, a vehicle, or the like) in a state in which the solution LA is accommodated in the reservoir 29A, the solution LB is accommodated in the reservoir 29B, and the solution LC is accommodated in the reservoir 29C.

Next, a procedure of performing mixing/reaction of the solutions LA, LB and LC by using the fluidic device 100A will be described with reference to FIGS. 1 to 5. First, a procedure of introducing the solution LA to the first fixed quantity division 18A and quantifying the introduced solution LA will be described.

First, the fixed quantity valves VA and VB of the circulation flow path 10 are closed, the waste liquid valves OB and OC of the discharge flow paths 13B and 13C are closed, and the waste liquid valve OA of the discharge flow path 13A and the introduction valve IA of the introduction flow path 12A are opened. Accordingly, the circulation flow path 10 is in a state in which the first fixed quantity division 18A is divided from the second fixed quantity division 18B and the third fixed quantity division 18C. In addition, the waste liquid tank 7 is shielded with respect to the discharge flow paths 13B and 13C, and is opened and connected to the first fixed quantity division 18A of the circulation flow path 10 via the discharge flow path 13A. Further, the reservoir 29A is opened and connected to the first fixed quantity division 18A of the circulation flow path 10 via the penetration section 39A and the introduction flow path 12A.

In this state, as the inside of the waste liquid tank 7 is suctioned from the tank suction hole at a negative pressure, the solution LA accommodated in the reservoir 29A is sequentially introduced to the penetration section 39A, the introduction flow path 12A, the first fixed quantity division 18A of the circulation flow path 10, the discharge flow path 13A and the waste liquid tank 7. While foreign substances may remain in the flow paths through which the solution LA is introduced to the waste liquid tank 7, since the foreign substances are trapped at an introduction tip side of the solution LA upon solution introduction and introduced into the waste liquid tank 7, a probability that foreign substances will remain in the circulation flow path 10 can be minimized.

In addition, in the reservoir 29A, air is present on the other end side of the accommodated solution LA (a side opposite to a section connecting to the penetration section 39A). For this reason, when the solution LA accommodated in the reservoir 29A is introduced into the circulation flow path 10, for example, while bubbles may arrive at the penetration section 39A earlier than the solution LA and may be mixed into the solution LA in the circulation flow path 10 when the fluidic device 100A is installed to be inclined with respect to a horizontal surface, since the reservoir 29A is constituted by the linear cavity formed in an in-plane direction of the lower surface 9a, arrival of the bubbles at the penetration section 39A earlier than the solution LA can be avoided since there is not a sufficient gap in which the bubbles move to overtake the solution LA against a liquid pressure of the solution LA accommodated in the cavity. In addition, as shown in FIG. 4, since the reservoir 29A is bent when the first linear section 29A1 and the second linear section 29A2 are continuously connected to each other, the bubbles are likely to remain in bent sections and arrival of the bubbles at the penetration section 39A earlier than the solution LA can be avoided.

Then, the waste liquid valve OA and the introduction valve IA are closed in a state in which an introduction tip side of the solution LA flows into the waste liquid tank 7 and an introduction rear end side remains in the introduction flow path 12A. Accordingly, the solution LA can be quantified according to a volume of the first fixed quantity division 18A. As described above, since the solution LA on the introduction tip side in which foreign substances may be present is discharged to the waste liquid tank 7 and the bubbles are being remained in the reservoir 29A, the solution LA in which the foreign substances or bubbles are not mixed in is quantified in the first fixed quantity division 18A of the circulation flow path 10.

Next, in introducing and quantifying the solution LB into the second fixed quantity division 18B, first, the fixed quantity valves VB and VC of the circulation flow path 10 are closed, the waste liquid valves OA and OC of the discharge flow paths 13A and 13C are closed, and the waste liquid valve OB of the discharge flow path 13B and the introduction valve IB of the introduction flow path 12B are opened. Accordingly, the circulation flow path 10 is in a state in which the second fixed quantity division 18B is divided with respect to the first fixed quantity division 18A and the third fixed quantity division 18C. In addition, the waste liquid tank 7 is shielded with respect to the discharge flow paths 13A and 13C, and is opened and connected to the second fixed quantity division 18B of the circulation flow path 10 via the discharge flow path 13B. Further, the reservoir 29B is opened and connected to the second fixed quantity division 18B of the circulation flow path 10 via the penetration section 39B and the introduction flow path 12B.

In this state, as the inside of the waste liquid tank 7 is suctioned from the tank suction hole at a negative pressure, the solution LB accommodated in the reservoir 29B is sequentially introduced into the penetration section 39B, the introduction flow path 12B, the second fixed quantity division 18B of the circulation flow path 10, the discharge flow path 13B and the waste liquid tank 7. Also in the solution LB, since foreign substances remaining in the flow paths through which the solution LB is introduced into the waste liquid tank 7 are caught at the introduction tip side of the solution LB upon solution introduction and introduced into the waste liquid tank 7, probability that the foreign substances remain in the circulation flow path 10 can be minimized.

In addition, even in the reservoir 29B, arrival of the bubbles at the penetration section 39B earlier than the solution LB can be avoided without a sufficient gap in which the bubbles moves to overtake the solution LB. In addition, as shown in FIG. 4, since the reservoir 29B is bent as a first linear section 29B1 and a second linear section 29B2 which are continuously connected to each other in a zigzag manner, the bubbles are likely to remain in the bent sections and arrival of the bubbles at the penetration section 39B earlier than the solution LB can be further avoided.

Then, the waste liquid valve OB and the introduction valve IB are closed in a state in which the solution LB at an introduction tip side flows into the waste liquid tank 7 and the solution LB at an introduction rear end remains in the introduction flow path 12B. Accordingly, the solution LB can be quantified according to a volume of the second fixed quantity division 18B. As described above, since the solution LB on the introduction tip side at which the foreign substances may be present is discharged to the waste liquid tank 7 and the bubbles are being remained in the reservoir 29B, the solution LB with which the foreign substances or bubbles are not mixed is quantified in the second fixed quantity division 18B of the circulation flow path 10.

Next, in introducing and quantifying the solution LC in the third fixed quantity division 18C, first, the fixed quantity valves VA and VC of the circulation flow path 10 are closed, the waste liquid valves OA and OB of the discharge flow paths 13A and 13B are closed, and the waste liquid valve OC of the discharge flow path 13C and the introduction valve IC of the introduction flow path 12C are opened. Accordingly, the circulation flow path 10 is in a state in which the third fixed quantity division 18C is divided with respect to the first fixed quantity division 18A and the second fixed quantity division 18B. In addition, the waste liquid tank 7 is shielded with respect to the discharge flow paths 13A and 13B, and opened and connected to the third fixed quantity division 18C of the circulation flow path 10 via the discharge flow path 13C. Further, the reservoir 29C is opened and connected to the third fixed quantity division 18C of the circulation flow path 10 via the penetration section 39C and the introduction flow path 12C.

In this state, as the inside of the waste liquid tank 7 is suctioned from the tank suction hole at a negative pressure, the solution LC accommodated in the reservoir 29C is sequentially introduced into the penetration section 39C, the introduction flow path 12C, the third fixed quantity division 18C of the circulation flow path 10, the discharge flow path 13C and the waste liquid tank 7. Even in the solution LC, since the foreign substances remaining in the flow paths through which the solution LC is introduced into the waste liquid tank 7 are caught at the introduction tip side of the solution LC upon solution introduction and introduced into the waste liquid tank 7, probability that the foreign substances remain in the circulation flow path 10 can be minimized.

In addition, even in the reservoir 29C, arrival of the bubbles at the penetration section 39C earlier than the solution LC can be avoided without a sufficient gap in which the bubbles move to overtake the solution LC. In addition, as shown in FIG. 4, since the reservoir 29C is bent as a first linear section 29C1 and a second linear section 29C2 which are continuously connected to each other in a zigzag manner, the bubbles are likely to remain in the bent sections and arrival of the bubbles at the penetration section 39C earlier than the solution LC can be avoided.

Then, the waste liquid valve OC and the introduction valve IC are closed in a state in which the solution LC at an introduction tip side flows into the waste liquid tank 7 and the solution LC at an introduction rear end side remains in the introduction flow path 12C. Accordingly, the solution LC can be quantified according to a volume of the third fixed quantity division 18C. As described above, since the solution LC on the introduction tip side at which foreign substances may be present is discharged to the waste liquid tank 7 and the bubbles are being remained in the reservoir 29C, the solution LC with which the foreign substances or bubbles are not mixed is quantified in the third fixed quantity division 18C of the circulation flow path 10.

When the solutions LA, LB and LC are quantified and introduced into the circulation flow path 10, the solutions LA, LB and LC in the circulation flow path 10 are delivered and circulated using a pump. In the solutions LA, LB and LC that circulate through the circulation flow path 10, due to mutual action (friction) between the flow path wall surface in the flow path and the solutions, a flow velocity around the wall surface becomes slow, and a flow velocity at a center of the flow path becomes fast. As a result, since a distribution in the flow velocities of the solutions LA, LB and LC are generated, mixing of the solutions can be promoted. For example, when the pump is driven, convection currents occur in the solutions LA, LB and LC of the circulation flow path 10, and mixing of the plurality of solutions LA, LB and LC is promoted. The pump may be a pump valve that can deliver a solution by opening and closing the above-mentioned valve.

Hereinabove, as described above, in the fluidic device 100A of the embodiment, since the reservoirs 29A, 29B and 29C are constituted by linear cavities formed in the in-plane direction of the lower surface 9a, arrival and mixing of the bubbles in the reservoirs 29A, 29B and 29C at the circulation flow path 10 earlier than the solutions LA, LB and LC can be avoided. Accordingly, in the fluidic device 100A of the embodiment, supply of the solutions LA, LB and LC from the reservoirs 29A, 29B and 29C to the circulation flow path 10 can be easily performed. In addition, in the fluidic device 100A of the embodiment, since the reservoirs 29A, 29B and 29C are bent and meander, even they are formed with linear cavities it is possible to accommodate sufficient volumes of the solutions LA, LB and LC, to make it more likely to trap the bubbles in the bent sections, and to further avoid the mixing of the bubbles into the circulation flow path 10.

Further, while a procedure of sequentially introducing the solutions LA, LB and LC into the first fixed quantity division 18A, the second fixed quantity division 18B and the third fixed quantity division 18C has been exemplarily described in the embodiment, there is no limitation to this procedure and a procedure of simultaneously introducing the solutions LA, LB and LC into the first fixed quantity division 18A, the second fixed quantity division 18B and the third fixed quantity division 18C may be provided.

When this procedure is employed, in a state in which the fixed quantity valves VA, VB and VC are closed to divide the first fixed quantity division 18A, the second fixed quantity division 18B and the third fixed quantity division 18C, by performing a negative pressure suction inside the waste liquid tank 7 from the tank suction hole after the waste liquid valves OA, OB and OC and the introduction valves IA, IB and IC are opened, it is possible to collectively perform a quantification and introduction of the solution LA into the first fixed quantity division 18A, the solution LB into the second fixed quantity division 18B and the solution LC into the third fixed quantity division 18C.

As a system according to an embodiment, the fluidic device 100A and a control unit (not shown) are provided. The control unit is connected to the valves (the fixed quantity valves VA, VB and VC, the introduction valves IA, IB and IC, and the waste liquid valves OA, OB and OC) installed in the fluidic device 100A via connecting lines (not shown), and controls opening and closing of the valves. According to the system of the embodiment, mixing in the fluidic device 100A can be performed.

### Second Embodiment

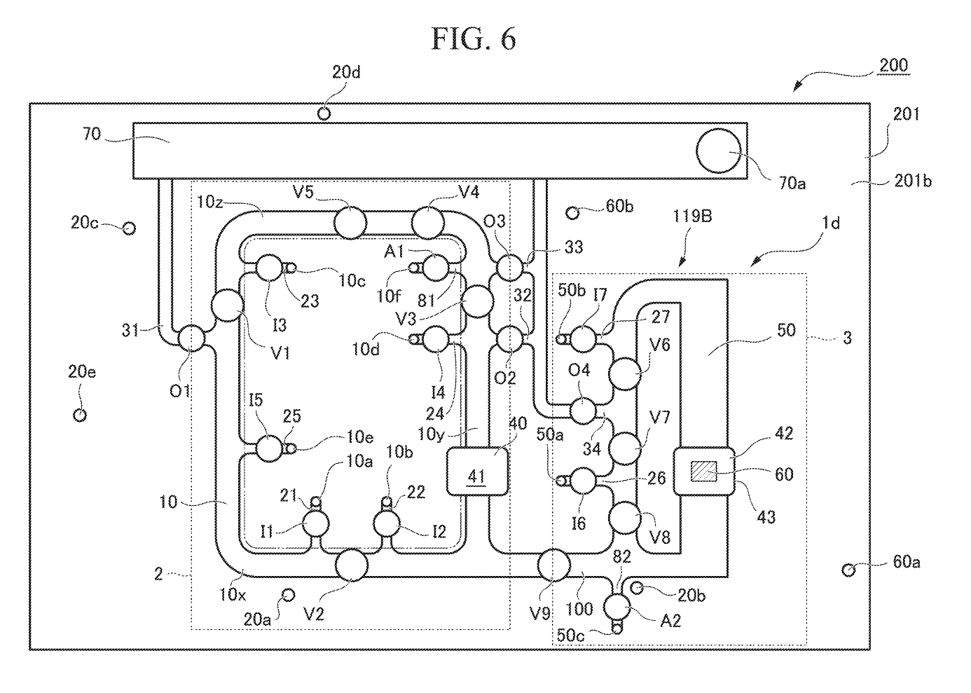

Next, a second embodiment of the fluidic device will be described with reference to FIGS. 6 to 11. In the drawings, components the same as those of the first embodiment shown in FIGS. 1 to 5 are designated by the same reference numerals and description thereof will be omitted.

FIG. 6 is a plan view schematically showing a fluidic device 200 of the second embodiment. The fluidic device 200 is, for example, a device configured to detect an antigen (a specimen substance, a biomolecule) that is a detection target included in an analytical specimen using an immunological response and an enzyme reaction. The fluidic device 200 includes a substrate 201 in which flow paths and valves are formed. FIG. 6 schematically shows a reaction layer 119B on the side of an upper surface 201b of the substrate 201. Further, while a part of the reaction layer 119B is formed on a lower surface side of the upper plate 6, here, it will be described such as it is formed on the substrate 201 other than the upper plate 6.

The fluidic device 200 includes a circulation-type mixer 1d. The circulation-type mixer 1d includes a first circulation section 2 through which a liquid containing carrier particles circulates, and a second circulation section 3 through which a liquid introduced from the circulation flow path 10 circulates. The first circulation section 2 includes the circulation flow path 10 through which a liquid containing carrier particles circulates, circulation flow path valves V1, V2 and V3, and a capturing section 40. The second circulation section 3 includes a second circulation flow path 50 through which a liquid introduced from the circulation flow path circulates, a capturing section 42 installed in the second circulation flow path 50, and a detector 60 installed in the second circulation flow path 50 and configured to detect a specimen substance bonded to the carrier particles. In the first circulation section 2, since the specimen substance is circulated in the circulation flow path 10 and is bonded to the carrier particles and a detection assisting material (for example, a labeling substance), it is possible to perform preprocessing of detecting a specimen substance. The preprocessed specimen substance is delivered from the first circulation section 2 to the second circulation section 3. In the second circulation section 3, the preprocessed specimen substance is detected in the second circulation flow path 50. Since the preprocessed specimen substance is circulated in the second circulation flow path 50, the preprocessed specimen substance comes in contact with the detector 60 repeatedly and is efficiently detected.

The capturing section 40 is formed on the circulation flow path 10, and includes a capturing means installation section 41 on which a capturing means configured to capture carrier particles can be installed. The carrier particles are particles that can react with a specimen substance that is a detection target, as an example. The carrier particles used in the embodiment may be exemplified as magnetic beads, magnetic particles, metal nanoparticles, agarose beads, plastic beads, and so on. The specimen substance is a biomolecule such as a nucleic acid, DNA, RNA, a peptide, a protein, extracellular endoplasmic reticulum, or the like. A reaction between the carrier particles and the specimen substance is exemplified as, for example, bonding between the carrier particles and the specimen substance, adsorption between the carrier particles and the specimen substances, modification of the carrier particles due to the specimen substance, a chemical change of the carrier particles due to the specimen substance, or the like. When the capturing section 40 uses magnetic beads or magnetic particles in the carrier particles as an example, a magnetic force generating source such as a magnet or the like may be exemplified as the capturing means. As another capturing means, for example, a column having a filler that can be bonded to the carrier particles, an electrode that can attract the carrier particles, or the like, is exemplified.

The detector 60 is disposed to face the capturing section 42 such that the specimen substance, which is bonded to the carrier particles captured by the capturing section 42 having the same configuration as the capturing section 40, can be detected.

Introduction flow paths 21, 22, 23, 24 and 25 configured to respectively introduce first to fifth solutions are connected to the circulation flow path 10. Introduction flow path valves I1, I2, I3, I4 and I5 configured to open and close the introduction flow paths are installed in the introduction flow paths 21, 22, 23, 24 and 25, respectively. In addition, the introduction flow path 81 configured to introduce (or discharge) air is connected to the circulation flow path 10, and an introduction flow path valve A1 configured to open and close the introduction flow path is installed in the introduction flow path 81. Discharge flow paths 31, 32 and 33 are connected to the circulation flow path 10. Discharge flow path valves O1, O2 and O3 configured to open and close the discharge flow path are installed in the discharge flow paths 31, 32 and 33. The first circulation flow path valve V1, the second circulation flow path valve V2 and the third circulation flow path valve V3 configured to divide the circulation flow path 10 are installed in the circulation flow path 10. The first circulation flow path valve V1 is disposed in the vicinity of the connecting section between the discharge flow path 31 and the circulation flow path 10. The second circulation flow path valve V2 is disposed between and in the vicinity of the connecting section between the introduction flow path 21 and the circulation flow path 10 and the connecting section between the introduction flow path 22 and the circulation flow path 10. The third circulation flow path valve V3 is disposed between and in the vicinity of the connecting section between the discharge flow path 32 and the circulation flow path 10 and the connecting section between the discharge flow path 33 and the circulation flow path 10.

In this way, the circulation flow path 10 is divided into three flow paths 10x, 10y and 10z when the first circulation flow path valve V1, the second circulation flow path valve V2 and the third circulation flow path valve V3 are closed, and at least one of the introduction flow path and the discharge flow path is connected to each of the divisions.

Introduction flow paths 26 and 27 are connected to the second circulation flow path 50. Introduction flow path valves I6 and I7 configured to open and close the introduction flow path are installed in the introduction flow paths 26 and 27. In addition, an introduction flow path 82 configured to introduce air is connected to the second circulation flow path 50, and an introduction flow path valve A2 configured to open and close the introduction flow path is installed in the introduction flow path 82. A discharge flow path 34 is connected to the second circulation flow path 50. A discharge flow path valve O4 configured to open and close the discharge flow path is installed in the discharge flow path 34.

Pump valves V3, V4 and V5 are installed in the circulation flow path 10. Here, the third circulation flow path valve V3 also functions as a pump valve. Pump valves V6, V7 and V8 are installed in the second circulation flow path 50.

For example, a volume in the second circulation flow path 50 is preferably set to be smaller than a volume in the circulation flow path 10. Here, a volume in a circulation flow path includes the volume in the circulation flow path when a liquid in the circulation flow path is circulated. The volume in the circulation flow path 10 is, for example, the volume in the circulation flow path 10 when the valves V1, V2, V3, V4 and V5 are opened and the valves I1, I2, I3, I4, I5, O1, O2, O3, A1 and V9 are closed. The volume in the second circulation flow path 50 is, for example, the volume in the second circulation flow path 50 when the valves V6, V7 and V8 are opened and the valves I6, I7, O4, A2 and V9 are closed. For example, since the volume in the second circulation flow path 50 is smaller than the volume in the circulation flow path 10, the liquid that circulates through the second circulation flow path 50 is smaller in quantity than the liquid that circulates through the circulation flow path 10. For this reason, in the fluidic device 200, an amount of an agent (reagent) used for detection can be minimized. In addition, the fluidic device 200 can improve detection sensitivity because the volume in the second circulation flow path 50 is smaller than the volume in the circulation flow path 10. For example, when the detection target is dispersed or dissolved in the liquid in the second circulation flow path 50, a detection sensitivity can be improved by reducing the liquid amount in the second circulation flow path 50. In addition, the volume in the second circulation flow path 50 may be larger than the volume in the circulation flow path 10. In this case, in the fluidic device 200, the liquid that circulates through the second circulation flow path 50 is larger in quantity than the liquid that circulates through the circulation flow path 10. In this case, for example, the fluidic device 200 transports the liquid that circulates through the circulation flow path 10 to the second circulation flow path 50, and fills the second circulation flow path 50 with the liquid by adding more of a measurement liquid or a substrate liquid.

The circulation flow path 10 and the second circulation flow path 50 are connected by the connecting flow path 100 that connects the circulation flow paths. The connecting flow path valve V9 configured to open and close the connecting flow path 100 is installed in the connecting flow path 100. The fluidic device 200 circulates the liquid through the circulation flow path 10 to perform preprocessing in a state in which the connecting flow path valve V9 is closed. After preprocessing of the liquid, the connecting flow path valve V9 is opened and the liquid is delivered to the second circulation flow path through the connecting flow path. After that, the connecting flow path valve V9 is closed, and the liquid is circulated through the second circulation flow path to perform a detection reaction. Accordingly, since the specimen after preprocessing is delivered to the second circulation flow path after required preprocessing is performed, circulation of an unnecessary material through the second circulation flow path 50 can be prevented. For this reason, unnecessary contamination or noise upon detection is suppressed. In addition, for example, in the circulation flow path 10 and the second circulation flow path 50, the flow paths in which the liquid can circulate are not shared by each other. In the fluidic device 200, since the flow paths in which the liquid can circulate are not shared by each other, the possibility that residues stuck to the wall surface in the circulation flow path 10 is circulated through the second circulation flow path 50 is reduced, and it is possible to reduce contamination upon detection in the second circulation flow path 50 due to the residues remaining in the circulation flow path 10.

The fluidic device 200 includes introduction inlets for a specimen, a reagent and air that are introduced. The fluidic device 200 includes a first reagent introduction inlet 10a serving as a penetration section installed on a terminal of the introduction flow path 21, an analytical specimen introduction inlet 10b serving as a penetration section installed on a terminal of the introduction flow path 22, a second reagent introduction inlet 10c serving as a penetration section installed on a terminal of the introduction flow path 23, a cleaning liquid introduction inlet 10d serving as a penetration section installed on a terminal of the introduction flow path 24, a transport liquid introduction inlet 10e serving as a penetration section installed on a terminal of the introduction flow path 25, and an air introduction inlet 10f installed on a terminal of an introduction flow path 81.

The first reagent introduction inlet 10a, the analytical specimen introduction inlet 10b, the second reagent introduction inlet 10c, the cleaning liquid introduction inlet 10d, the transport liquid introduction inlet 10e and the air introduction inlet 10f are opened to the upper surface 201b of the substrate 201. The first reagent introduction inlet 10a is connected to a reservoir 215R, which will be described below. The analytical specimen introduction inlet 10b is connected to a reservoir 213R, which will be described below. The second reagent introduction inlet 10c is connected to a reservoir 214R, which will be described below. The cleaning liquid introduction inlet 10d is connected to a reservoir 212R, which will be described below. The transport liquid introduction inlet 10e is connected to a reservoir 222R, which will be described below.

The fluidic device 200 includes a substrate liquid introduction inlet 50a serving as a penetration section installed on a terminal of the introduction flow path 26, a measurement liquid introduction inlet 50b serving as a penetration section installed on a terminal of the introduction flow path 27, and an air introduction inlet 50c installed on a terminal of the introduction flow path 82. The substrate liquid introduction inlet 50a, the measurement liquid introduction inlet 50b and the air introduction inlet 50c are opened to the upper surface 201b of the substrate 201. The substrate liquid introduction inlet 50a is connected to a reservoir 224R, which will be described below. The measurement liquid introduction inlet 50b is connected to a reservoir 225R, which will be described below.

The discharge flow paths 31, 32 and 33 are connected to the waste liquid tank 70. The waste liquid tank 70 includes an outlet 70a. The outlet 70a is opened to the upper surface 201b of the substrate 201, and as an example, connected to an external suction pump (not shown) to suction the liquid at a negative pressure.

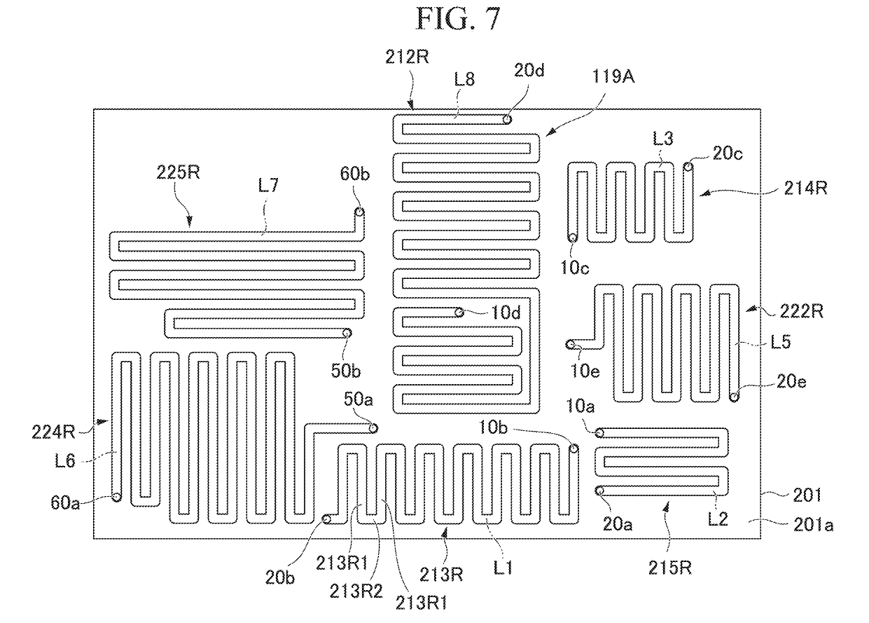

Next, FIG. 7 is a bottom view schematically showing a reservoir layer 119A on the side of a lower surface 201a of the substrate 201. As shown in FIG. 7, the reservoir layer 119A has a plurality of (in FIG. 7, seven) flow path type reservoirs 212R, 213R, 214R, 215R, 222R, 224R and 225R disposed in the lower surface 201a of the substrate 201. The reservoirs 212R, 213R, 214R, 215R, 222R, 224R and 225R can accommodate solutions independently from each other. The reservoirs 212R, 213R, 214R, 215R, 222R, 224R and 225R are constituted by linear cavities formed in an in-plane direction of the lower surface 201a (for example, one direction or a plurality of directions in a surface of the lower surface 201a, a direction parallel to a surface direction of the lower surface 201a, or the like). Bottom surfaces of the cavities in the reservoirs 212R, 213R, 214R, 215R, 222R, 224R and 225R are substantially flush with each other. The cavities in the reservoirs 212R, 213R, 214R, 215R, 222R, 224R and 225R have the same width. A cross section of the cavity has a rectangular shape as an example. For example, a width of the cavity is 1.5 mm, and a depth is 1.5 mm. Volumes of the cavities in the reservoirs 212R, 213R, 214R, 215R, 222R, 224R and 225R are set according to quantities of the accommodated solutions (volumes of the solutions). The reservoirs 212R, 213R, 214R, 215R, 222R, 224R and 225R have lengths that are set according to the quantities of the accommodated solutions. At least two reservoirs of the reservoirs 212R, 213R, 214R, 215R, 222R, 224R and 225R according to the embodiment have different volumes with each other.

As an example, the reservoir 212R has a length of 360 mm and a volume of about 810 μL. The reservoir 213R has a length of 160 mm and a volume of about 360 μL. The reservoirs 214R and 215R each have a length of 110 mm and a volume of about 248 μL. The reservoir 222R has a length of 150 mm and a volume of about 338 μL. The reservoir 224R has a length of 220 mm and a volume of about 500 μL. The reservoir 225R is a length of 180 mm and a volume of about 400 μL.

The reservoirs 212R, 213R, 214R, 215R, 222R, 224R and 225R are formed in a serpentine shape extending in a predetermined direction while linear cavities are bend zigzag in upward, downward, leftward and rightward. For example, when the reservoir 213R is described, the reservoir 213R is formed in a serpentine shape having a plurality of (in FIG. 7, thirteen) first linear sections 213R1 disposed in a predetermined direction (in FIG. 7, a leftward/rightward direction in the drawing) while being parallel with each other, and second linear sections 213R2 that repeatedly connects connecting places of end portions of the neighboring first linear sections 213R1 alternately at one end side and at the other end side of the first linear sections 213R1. For example, the reservoirs 212R, 214R, 215R, 222R, 224R and 225R are also formed in a serpentine shape like the reservoir 213R.

One end side of the reservoir 212R is connected to a cleaning liquid introduction inlet (a penetration section) 10d that penetrates the substrate 201 in the thickness direction. The other end side of the reservoir 212R is connected to an atmospheric opening section 20d. The atmospheric opening section 20d penetrates the substrate 201 in the thickness direction. One end side of the reservoir 213R is connected to an analytical specimen introduction inlet (a penetration section) 10b that penetrates the substrate 201 in the thickness direction. The other end side of the reservoir 213R is connected to an atmospheric opening section 20b. The atmospheric opening section 20b penetrates the substrate 201 in the thickness direction. One end side of the reservoir 214R is connected to a second reagent introduction inlet (a penetration section) 10c that penetrates the substrate 201 in the thickness direction. The other end side of the reservoir 214R is connected to an atmospheric opening section 20c. The atmospheric opening section 20c penetrates the substrate 201 in the thickness direction. One end side of the reservoir 215R is connected to a first reagent introduction inlet (a penetration section) 10a that penetrates the substrate 201 in the thickness direction. The other end side of the reservoir 215R is connected to an atmospheric opening section 20a. The atmospheric opening section 20a penetrates the substrate 201 in the thickness direction. One end side of the reservoir 222R is connected to a transport liquid introduction inlet (a penetration section) 10e that penetrates the substrate 201 in the thickness direction. The other end side of the reservoir 222R is connected to an atmospheric opening section 20e. The atmospheric opening section 20e penetrates the substrate 201 in the thickness direction. One end side of the reservoir 224R is connected to a substrate liquid introduction inlet (a penetration section) 50a that penetrates the substrate 201 in the thickness direction. The other end side of the reservoir 224R is connected to an atmospheric opening section 60a. The atmospheric opening section 60a penetrates the substrate 201 in the thickness direction. One end side of the reservoir 225R is connected to a measurement liquid introduction inlet (a penetration section) 50b that penetrates the substrate 201 in the thickness direction. The other end side of the reservoir 225R is connected to an atmospheric opening section 60b. The atmospheric opening section 60b penetrates the substrate 201 in the thickness direction. Air holes (not shown) in communication with the atmospheric opening sections 20a, 20b, 20c, 20d, 20e, 60a and 60b are formed in the upper plate 6 to penetrate the upper plate 6 in the thickness direction.

In addition, as shown in FIG. 7, a cleaning liquid L8 as a solution is accommodated in the reservoir 212R to 800 μL as an example. The analytical specimen liquid L1 containing a specimen substance as a solution is accommodated in the reservoir 213R to 300 μL as an example. A second reagent liquid L3 including a labeling substance (a detection assisting material) as a solution is accommodated in the reservoir 214R to 200 μL as an example. A first reagent liquid L2 containing carrier particles as a solution is accommodated in the reservoir 215R to 200 μL as an example. A transport liquid L5 as a solution is accommodated in the reservoir 222R to 300 μL as an example.

A substrate liquid L6 as a solution is accommodated in the reservoir 224R to 500 μL as an example. A measurement liquid L7 as a solution is accommodated in the reservoir 225R to 400 μL as an example. The volumes of the reservoirs can be easily adjusted by varying at least one of the width, the depth and the length.

In addition, for example, according to a method of manufacturing the fluidic device 200, like the fluidic device 100A, the fluidic device 200 is manufactured by forming the reservoir layer 119A and the reaction layer 119B on the substrate 201, installing the various valves on the upper plate, and then, bonding the upper plate, the lower plate and the substrate 201 using a bonding means such as adhesive or the like and integrating them in a stacked state. The predetermined solutions are injected into the reservoirs 212R, 213R, 214R, 215R, 222R, 224R and 225R via the above-mentioned air holes with respect to the manufactured fluidic device 200. An amount of the injected solutions is, for example, about two times the amount of the solutions used for detection of the specimen substance, which will be described below. In addition, a suction force when the solution is injected is, for example, 5 kPa.

### Mixing Method/Capturing Method/Detecting Method Using Fluidic Device 200

Next, a mixing method, a capturing method and a detecting method using the fluidic device 200 having the above-mentioned configuration will be described. Since the fluidic device 200 includes the circulation-type mixer 1d, hereinafter, the mixing method, the capturing method and the detecting method using the circulation-type mixer 1d will be described. The detecting method of the embodiment detects an antigen (a specimen substance, a biomolecule) that is a detection target included in the analytical specimen using an immunological response and an enzyme reaction.

### Introduction Process/Division Process

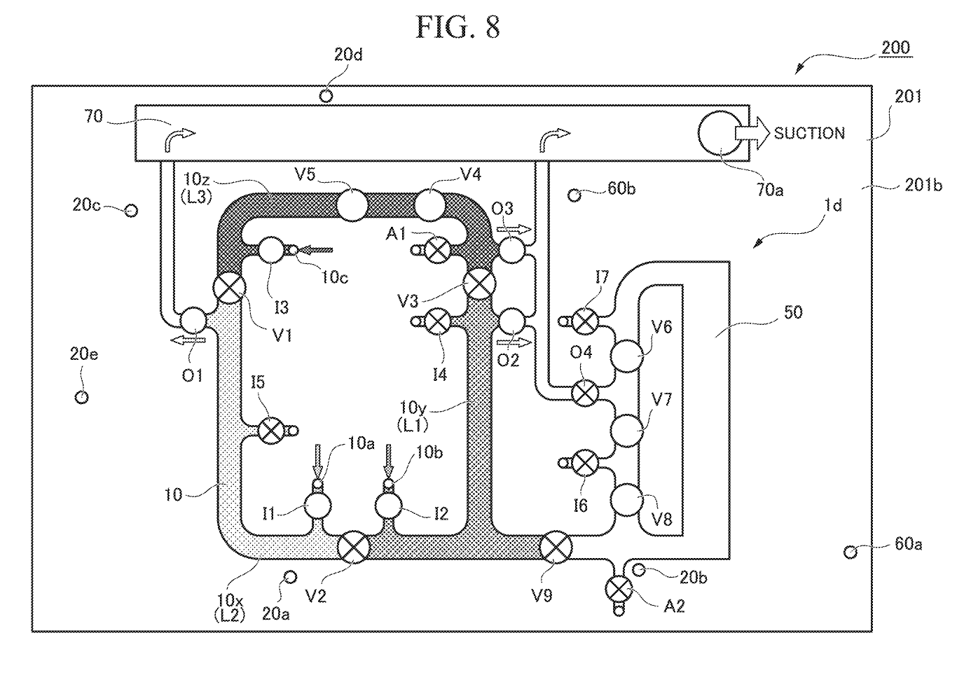

First, as shown in FIG. 8, the first circulation flow path valve V1, the second circulation flow path valve V2, the third circulation flow path valve V3 and the introduction flow path valves I5, I4 and A1 are closed. Accordingly, the circulation flow path 10 is divided into the flow path 10x, the flow path 10y and the flow path 10z.

Next, the first reagent liquid L2 containing carrier particles is introduced into the flow path 10x from the first reagent introduction inlet 10a connected to the reservoir 215R of the reservoir layer 119A, the analytical specimen liquid L1 containing a specimen substance is introduced into the flow path 10y from the analytical specimen introduction inlet 10b connected to the reservoir 213R, and the second reagent liquid L3 containing a labeling substance (a detection assisting material) is introduced into the flow path 10z from the second reagent introduction inlet 10c connected to the reservoir 214R.

Introduction of the analytical specimen liquid L1, the second reagent liquid L3 and the first reagent liquid L2 from the reservoirs 213R, 214R and 215R is performed by suctioning the liquids from the outlet 70a of the waste liquid tank 70 at a negative pressure in a state in which the discharge flow path valves O1, O2 and O3 and the introduction flow path valves I2 and I3 are opened. Even when the analytical specimen liquid L1, the second reagent liquid L3 and the first reagent liquid L2 are introduced, since the reservoirs 213R, 214R and 215R are constituted by linear cavities that are formed in a zigzag manner in the in-plane direction, the liquids can be easily introduced into the flow paths 10x, 10y and 10z while the bubbles present at sides opposite to the liquid introduction inlets 10a, 10b and 10c do not move to the liquid introduction inlets 10a, 10b and 10c and do not arrive at the flow paths 10x, 10y and 10z against the liquid pressures of the liquids.

In the embodiment, the analytical specimen liquid L1 contains an antigen as a detection target (a specimen substance). A body fluid such as blood, urine, saliva, blood plasma, blood serum, or the like, cell extracts, a tissue crushing liquid, and so on, are exemplified as the analytical specimen liquid. In addition, in the embodiment, magnetic particles are used as the carrier particles contained in the first reagent liquid L2.

An antibody A specifically bonded to an antigen (a specimen substance) of a detection target is fixed to a surface of the magnetic particle. In addition, in the embodiment, the second reagent liquid L3 contains an antibody B specifically bonded to an antigen of a detection target. Alkaline phosphatase (a detection assisting material, enzyme) is fixed to and labeled on the antibody B.

### Mixing Process

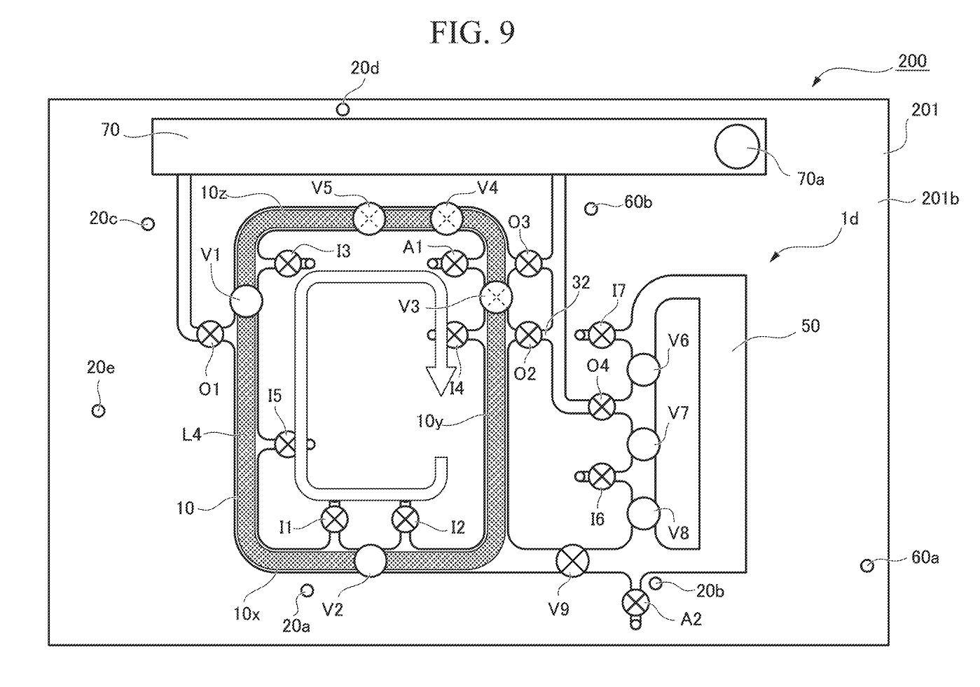

Next, as shown in FIG. 9, the introduction flow path valves I1, I2 and I3 are closed. Accordingly, communication with the flow path connected to the circulation flow path 10 is blocked, and the circulation flow path 10 is closed. The first circulation flow path valve V1, the second circulation flow path valve V2, and the third circulation flow path valve V3 are opened, the pump valves V3, V4 and V5 are operated, the first reagent liquid L2 (a first reagent), the analytical specimen liquid L1 (an analytical specimen), and the second reagent liquid L3 (a second reagent) are circulated and mixed in the circulation flow path 10, and a mixed liquid L4 of those is obtained. The antigen is bonded to the antibody A fixed to the carrier particles by the mixture of the first reagent liquid L2, the analytical specimen liquid L1 and the second reagent liquid L3, and the antibody B to which an enzyme is fixed is bonded to the antigen. Accordingly, a carrier particle-antigen-enzyme compound material (a carrier particle-specimen substance-detection assisting material compound material, a first compound material) is formed.

### Magnet Installing Process/Capturing Process

The capturing section 40 (see FIG. 6) includes a magnet installation section 41 on which a magnet that captures magnetic particles can be installed. The magnet is installed on the magnet installation section 41, and is in a capturable state in which the magnet is made close to the circulation flow path. In this state, the pump valves V3, V4 and V5 are operated, the liquid containing the carrier particle-antigen-enzyme compound material (the first compound material) is circulated in the circulation flow path 10, and the carrier particle-antigen-enzyme compound material is captured by the capturing section 40. The carrier particle-antigen-enzyme compound material flows through the circulation flow path in one direction or both directions, and circulates or reciprocates through the circulation flow path. FIG. 9 shows a state in which the carrier particle-antigen-enzyme compound material circulates in one direction. The compound material is captured on the wall surface in the circulation flow path 10 in the capturing section 40 and separated from the liquid element.

### Cleaning Process

The introduction flow path valve A1 and the discharge flow path valve O2 are opened, the third circulation flow path valve V3 is closed, suction is performed from the outlet 70a at a negative pressure, and air is introduced into the circulation flow path 10 via the introduction flow path 81 from the air introduction inlet 10f. Accordingly, the liquid element (waste liquid) separated from the carrier particle-antigen-enzyme compound material is discharged from the circulation flow path 10 via the discharge flow path 32. The waste liquid is stored in the waste liquid tank 70. When the third circulation flow path valve V3 is closed, the air is efficiently introduced into whole of the circulation flow path 10.

After that, the discharge flow path valve O2 and the third circulation flow path valve V3 are closed, the introduction flow path valve I4 and the discharge flow path valve O3 are opened, and suction is performed from the outlet 70a at a negative pressure. Accordingly, the cleaning liquid L8 is introduced into the circulation flow path 10 from the reservoir 212R via the cleaning liquid introduction inlet 10d and the introduction flow path 24. When the third circulation flow path valve V3 is closed, the cleaning liquid L8 is introduced to fill the circulation flow path 10. Even when the cleaning liquid L8 is introduced, since the reservoir 212R is constituted by a linear cavity that is formed zigzag in the in-plane direction, the cleaning liquid L8 can be introduced into the circulation flow path 10 while the bubbles present on the side opposite to a liquid introduction inlet 10d do not move to the liquid introduction inlet 10d and do not arrive at the circulation flow path 10 against a liquid pressure of the cleaning liquid L8. After that, the third circulation flow path valve V3 is opened, the introduction flow path valve 14 and the discharge flow path valve O2 are closed, the circulation flow path 10 is closed, the pump valves V3, V4 and V5 are operated, the cleaning liquid L8 is circulated in the circulation flow path 10, and the carrier particles are cleaned.

Next, the introduction flow path valve A1 and the discharge flow path valve O2 are opened, the third circulation flow path valve V3 is closed, suction is performed from the outlet 70a at a negative pressure, and air is introduced into the circulation flow path 10 from the air introduction inlet 10f via the introduction flow path 81. Accordingly, the cleaning liquid is discharged from the circulation flow path 10, and the antibody B in which the carrier particle-antigen-enzyme compound material is not formed is discharged from the inside of the circulation flow path 10. Further, introduction and discharge of the cleaning liquid may be performed a plurality of times. Removing efficiency of unnecessary objects is increased by repeatedly introducing the cleaning liquid, cleaning the flow paths and discharging the liquid after cleaning.

### Transport Process

The introduction flow path valve I5 and the discharge flow path valve O3 are opened, the discharge flow path valve O2 and the third circulation flow path valve V3 are closed, suction is performed from the outlet 70a at a negative pressure, and the transport liquid L5 is introduced into the circulation flow path 10 from the reservoir 222R via the transport liquid introduction inlet 10e and the introduction flow path 25. In addition, the introduction flow path valve I5 and the discharge flow path valve O2 are opened, the discharge flow path valve O3 and the third circulation flow path valve V3 are closed, suction is performed from the outlet 70a at a negative pressure, and the transport liquid L5 is introduced into the circulation flow path 10 from the transport liquid introduction inlet 10e connected to the reservoir 222R via the introduction flow path 25. Even when the transport liquid L5 is introduced, since the reservoir 222R is constituted by a linear cavity that is formed zigzag in the in-plane direction, the transport liquid L5 can be introduced into the circulation flow path 100 while bubbles present on the side opposite to a liquid introduction inlet 10e do not move to the liquid introduction inlet 10e and do not arrive at the circulation flow path 10 against a liquid pressure of the transport liquid L5.

Next, the third circulation flow path valve V3 is opened, the introduction flow path valve I5 and the discharge flow path valves O2 and O3 are closed, and the circulation flow path 10 is closed. Then, the magnet is removed from the magnet installation section 41 and made to a released state by moving it far from the circulation flow path, and releasing the capture of carrier particle-antigen-enzyme compound material captured on the wall surface in the circulation flow path 10 in the capturing section 40. The pump valves V3, V4 and V5 are operated, a transport liquid is circulated in the circulation flow path 10, and the carrier particle-antigen-enzyme compound material is dispersed in the transport liquid.

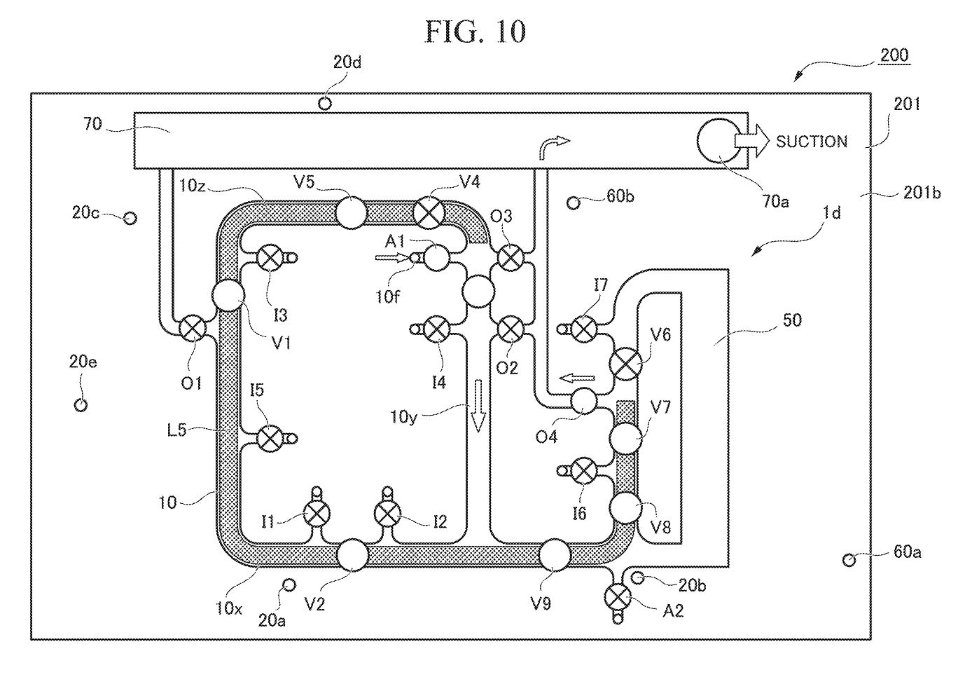

Next, as shown in FIG. 10, the introduction flow path valve A1, the connecting flow path valve V9 and the discharge flow path valve O4 are opened, suction is performed from the outlet 70a at a negative pressure, and air is introduced into the circulation flow path 10 from the air introduction inlet 10f via the introduction flow path 81. The transport liquid containing the carrier particle-antigen-enzyme compound material is extruded by the air, and the transport liquid L5 is introduced into the second circulation flow path 50 through a connecting flow path 100. Here, after the valve V6 is closed and the transport liquid L5 arrives at the connecting section between the discharge flow path 34 and the second circulation flow path 50, the valve V7 is closed at this time, and the inside of the second circulation flow path 50 is filled with the transport liquid. The carrier particle-antigen-enzyme compound material is transported to the second circulation flow path 50.

### Detecting Process

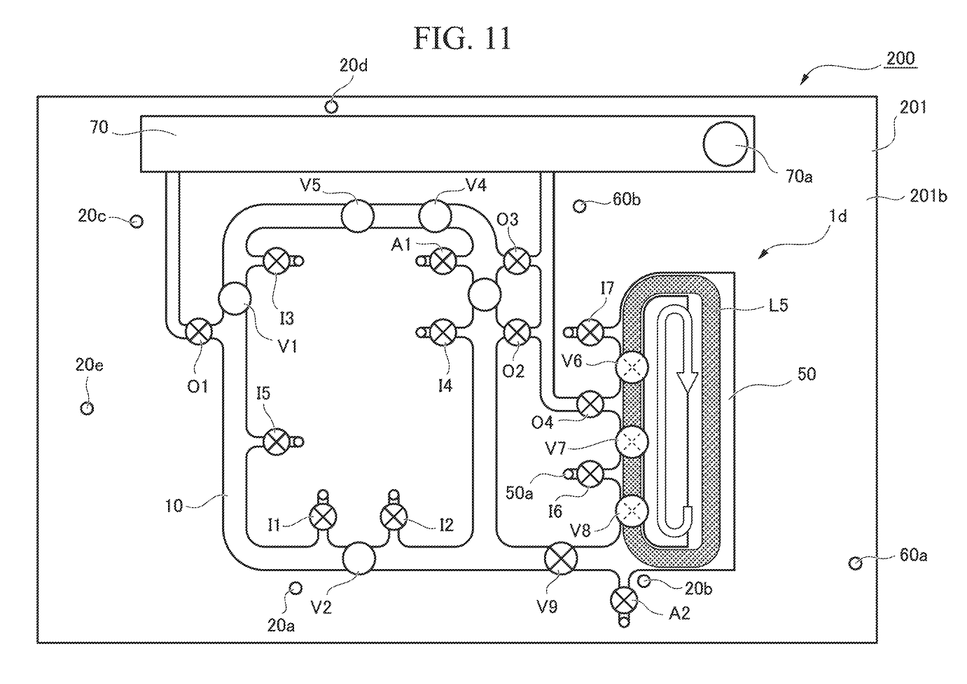

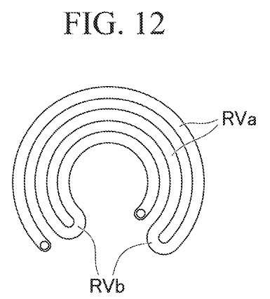

After transport of the transport liquid into the second circulation flow path 50 is terminated, as shown in FIG. 11, the connecting flow path valve V9 and the discharge flow path valve O4 are closed, the second circulation flow path 50 is closed, the pump valves V6, V7 and V8 are operated, the transport liquid L5 containing the carrier particle-antigen-enzyme compound material is circulated through the second circulation flow path 50, and the carrier particle-antigen-enzyme compound material is captured by the capturing section 42 (see FIG. 6).

The introduction flow path valve A2 and the discharge flow path valve O4 are opened, suction is performed from the outlet 70a at a negative pressure, and air is introduced into the second circulation flow path 50 from the air introduction inlet 50c via the introduction flow path 82. Accordingly, a liquid element (a waste liquid) of the transport liquid L5 separated from the carrier particle-antigen-enzyme compound material is discharged from the second circulation flow path 50 via the discharge flow path 34. The waste liquid is stored in the waste liquid tank 70. Here, the air is efficiently introduced into whole of the second circulation flow path 50 by closing the valve V6 or V7.

The introduction flow path valve I6 and the discharge flow path valve O4 are opened, the valve V7 is closed, suction is performed from the outlet 70a at a negative pressure, and the substrate liquid L6 is introduced into the second circulation flow path 50 from the reservoir 224R via the substrate liquid introduction inlet 50a and the introduction flow path 26. The substrate liquid L6 contains 3-(2′-spiroadamantane)-4-methoxy-4-(3″-phosphoryloxy) phenyl-1, 2-dioxetane (AMPPD), 4-aminophenyl phosphate (pAPP), or the like, that is a substrate of alkaline phosphatase (enzyme). Even when the substrate liquid L6 is introduced, since the reservoir 224R is constituted by a linear cavity that is formed zigzag in the in-plane direction, the substrate liquid L6 can be introduced into the second circulation flow path 50 while bubbles present on the side opposite to the substrate liquid introduction inlet 50a do not move to the substrate liquid introduction inlet 50a and do not arrive at the second circulation flow path 50 against a liquid pressure of the substrate liquid L6.

The discharge flow path valve O4 and the introduction flow path valve I6 are closed, the second circulation flow path 50 is closed, the pump valves V6, V7 and V8 are operated, the substrate liquid is circulated through the second circulation flow path 50, and the substrate reacts with the enzyme of the carrier particle-antigen-enzyme compound material.

The antigen of the detection target included in the analytical specimen can be detected as a chemiluminescence signal, an electrochemistry signal, or the like, using the above mentioned operation (a detecting method or the like). In this case, the detector 60 and the capturing section 42 may not be used in combination, and the capturing section may not be installed on the second circulation flow path 50.

The detecting method of the embodiment may be applied to analysis of a living body specimen, extracorporeal diagnosis, or the like.

The specimen substance can be detected by the fluidic device 200 through the above-mentioned procedure. Even in the fluidic device 200 of the embodiment, like the fluidic device 100A of the first embodiment, bubbles in the reservoirs 212R, 213R, 214R, 215R, 222R, 224R and 225R can be avoided from arriving at and being mixed with the circulation flow path 10 or the second circulation flow path 50 earlier than the solution. Accordingly, in the fluidic device 200 of the embodiment, supply of the solutions into the circulation flow path 10 or the second circulation flow path 50 from the reservoirs 212R, 213R, 214R, 215R, 222R, 224R and 225R can be easily performed without the bubbles being mixed, and detection accuracy of the specimen substance can be improved.

Further, in the embodiment, the case in which detection is performed using the detector 60 by introducing and circulating the substrate liquid L6 and the measurement liquid L7 as the liquid that circulates through the second circulation flow path to perform detection of the specimen substance has been exemplified. However, the liquid may be one kind of solution. In addition, a plurality of fixed quantity divisions may be installed in the second circulation flow path 50, and the liquid may be introduced and quantified to be circulated and mixed in each of the divisions.

In addition, while the configuration of the fluidic device or the detecting method using the antigen/antibody reaction has been described in the embodiment, the configuration may also be applied to a reaction using hybridization.

Hereinabove, while the embodiment has been described with reference to the accompanying drawings, of course the present invention is not limited to the example. The shapes, combinations, or the like, of the components shown in the above-mentioned example are exemplified, and various modifications may be made based on design requirements without departing from the scope of the present invention.

For example, while the reservoirs 29A, 29B, 29C, 212R, 213R, 214R, 215R, 222R, 224R and 225R according to the embodiment have the rectangular cross sections, there is no limitation to the configuration, and for example, a tapered cross-sectional shape that is tapered toward a bottom surface may be provided. When the configuration is employed, for example, when the substrate 9 is manufactured through injection molding, a mold release resistance can be reduced and moldability can be improved.

In addition, while the configuration in which the plurality of reservoirs have the same width and the same depth has been exemplified in the embodiment, there is no limitation to the configuration. The widths and the depths of the plurality of reservoirs may be set to, for example, different values according to flow characteristics of the accommodated solutions. For example, when the solutions are introduced into the circulation flow path by collectively suctioning the solutions from the plurality of reservoirs at a negative pressure, the widths and the depths may be set according to flow characteristics (a flow resistance or the like) of the solutions in the reservoirs such that various kinds of solutions are introduced into the circulation flow path at the same timing.

In addition, introduction of the various solutions from the reservoirs into the circulation flow path does not need to be performed at once, and may be introduced in multiple times. When the solutions are introduced in multiple times, a solution quantity at each time can be quantified by controlling an operation time of the liquid feeding pump or by installing a liquid detecting sensor and detecting that a tip of a gas-liquid interface passes through a quantification region.

In addition, while the configuration in which the reservoirs 29A, 29B, 29C, 212R, 213R, 214R, 215R, 222R, 224R and 225R each have a shape in which a linear cavity is formed zigzag has been exemplified in the embodiment, a configuration including a curved flow path that is a non-linear flow path may be provided. As the reservoir including the curved flow path, for example, a configuration having a U-shaped, W-shaped or C-shaped flow path, or as shown in FIG. 12, a configuration including a plurality of (in FIG. 12, three) first arc sections RVa that are formed concentrically and a plurality of second arc sections RVb configured to repeatedly connect the connecting places of the neighboring first arc sections RVa alternately at one end side and at the other end side of the first arc sections RVa in the radial direction may be provided. The curved reservoir is not limited to an arc shape and may be a spiral shape in which a distance to the axis is gradually increased around the axis perpendicular to one surface of the substrate.

In addition, while the configuration in which the reservoir layer 19A is disposed on the lower surface 9a of the substrate 9, the reaction layer 19B is disposed on the upper surface 9b of the substrate 9, the reservoir layer 119A is disposed on the lower surface 201a of the substrate 201 and the reaction layer 119B is disposed on the upper surface 201b of the substrate 201 has been exemplified in the embodiment, there is no limitation to the configuration. For example, when the reaction layer 19B is disposed on the upper surface 9b of the substrate 9, a configuration in which the reservoir layer is disposed on the upper surface of the lower plate 8 or a configuration in which the reservoir layer is disposed to cross the upper surface of the lower plate 8 and the lower surface 9a of the substrate 9 may be provided. In addition, for example, when the reservoir layer 119A is disposed on the lower surface 201a of the substrate 201, a configuration in which the reaction layer is disposed on the lower surface of the upper plate 6, a configuration in which the reaction layer is formed on the substrate different from the upper plate 6 and the substrate 201, or a configuration in which the reaction layer is disposed to cross the lower surface of the upper plate 6 and the upper surface 201b of the substrate 201 may be provided.

What is claimed is:

1. A fluidic device comprising:
a flow path into which a solution is introduced; and
a reservoir in which the solution is received and that supplies the solution to the flow path,
wherein the reservoir has a length in a direction in which the solution flows toward the flow path, and the length of the reservoir is larger than a width of the reservoir which is perpendicular to the direction in which the solution flows.

2. The fluidic device according to claim 1, wherein the length of the reservoir in the direction in which the solution flows is larger than a depth of the reservoir which is perpendicular to the length and the width of the reservoir.

3. The fluidic device according to claim 1, wherein a size of the width in the reservoir is a size such that bubbles do not move to overtake the solution.

4. The fluidic device according to claim 1, wherein the solution is accommodated in the reservoir.

5. The fluidic device according to claim 1, comprising a substrate, the reservoir being formed in one surface of the substrate,
wherein the reservoir is formed in a direction parallel to the one surface of the substrate, and
the flow path is formed at a side opposite to the one surface.

6. The fluidic device according to claim 1, comprising a substrate, the reservoir being formed in one surface of the substrate,
wherein a direction in which the solution flows in the reservoir is a direction parallel to the one surface of the substrate.

7. The fluidic device according to claim 1, comprising a valve disposed at least at a portion of the flow path and that controls opening and closing of the flow path,
wherein the flow path is divided into at least two flow paths by the valve.

8. The fluidic device according to claim 1, wherein the solution contains a cleaning liquid.

9. A fluidic device comprising:
a flow path;
a first reservoir in which a first solution is accommodated, that supplies the first solution to the flow path, and that has a length in a direction in which the first solution flows toward the flow path, and the length of the first reservoir is larger than a width of the first reservoir which is perpendicular to the direction in which the first solution flows; and
a second reservoir in which a second solution is accommodated, that supplies the second solution to the flow path, and that has a length in a direction in which the second solution flows toward the flow path, and the length of the second reservoir is larger than a width of the second reservoir which is perpendicular to the direction in which the second solution flows.

10. The fluidic device according to claim 9, wherein the flow path comprises a circulation flow path that circulates the first solution and the second solution.

11. The fluidic device according to claim 9, wherein the first solution and the second solution are mixed in the flow path.

12. A fluidic device comprising:
a substrate having a first surface in which a flow path to which a solution is introduced is formed;
a second substrate stacked on and bonded to the substrate while facing the first surface; and
a reservoir in which the solution is accommodated, that supplies the solution to the flow path, and that has a length in a direction in which the solution flows toward the flow path, and the length of the reservoir is larger than a width of the reservoir which is perpendicular to the direction in which the solution flows,
wherein, when seen in a direction in which the substrate and the second substrate are stacked, at least a part of the flow path and at least a part of the reservoir overlaps with each other.

13. The fluidic device according to claim 12, comprising a second flow path disposed in a portion at which at least a part of the flow path and at least a part of the reservoir overlaps with each other when seen in the direction in which the substrate and the second substrate are stacked, and that connects the flow path and the reservoir.

14. The fluidic device according to claim 12,
wherein the reservoir is formed in a second surface of the substrate which is formed at opposite side of the first surface of the substrate,
the fluidic device comprises a third substrate bonded to the substrate while facing the second surface.

15. A fluidic device comprising:
a flow path formed in one surface of a substrate and in which quantification or mixing of solutions is performed; and
a reservoir that is formed parallel to the other surface of the substrate which is formed at opposite side of the one surface of the substrate, in which the solution is accommodated, and that supplies the solution to the flow path.

16. The fluidic device according to claim 15, wherein a direction in which the solution flows toward the flow path in the reservoir is a direction parallel to the other surface of the substrate.

17. The fluidic device according to claim 15, wherein the flow path is a circulation flow path through which the solution is circulated.

18. A fluidic device comprising:
a substrate; and
a reservoir that is formed in the substrate and that includes at least two first flow paths which are parallel to each other and at least three second flow paths which are parallel to each other in a direction perpendicular to the first flow paths,
wherein the reservoir is formed in a zigzag shape in which the two first flow paths and the three second flow paths are alternately and repeatedly connected.
